(19) United States
(12) Patent Application Publication
(10) Pub. No.: US 2018/0238459 A1
(43) Pub. Date: Aug. 23, 2018

(54) Check Valve

(71) Applicant: Kerr Machine Co., Sulphur, OK (US)

(72) Inventors: Mark S. Nowell, Ardmore, OK (US); Kelcy Jake Foster, Ardmore, OK (US); Guy J. Lapointe, Sulphur, OK (US); Christopher Todd Barnett, Stratford, OK (US); Michael Cole Thomas, Ardmore, OK (US); Michael Eugene May, Ardmore, OK (US)

(21) Appl. No.: 15/900,984

(22) Filed: Feb. 21, 2018

Related U.S. Application Data
(60) Provisional application No. 62/462,006, filed on Feb. 22, 2017.

(51) Int. Cl. F16K 15/03

(52) U.S. Cl. CPC F16K 15/03

(57) ABSTRACT

A check valve with a flapper for directing high pressure abrasive fluid away from its sealing face. The check valve has a flapper which opens when fluid travels from an inlet to an outlet. The flapper closes when fluid flow stops or reverses by sealing a flat sealing face to a seal formed in a shoulder face of the valve. A surface feature protrudes from near the flat sealing face and forms a slanted face opposed to the direction of flow through the valve. This slanted face interfaces with fluid flow to more easily open the valve and directs flow away from the sealing face to reduce wear.

### FIELD

The present invention is directed to a check valve. The check valve is designed with features and materials which limit wear associated with abrasive fluids used in oil and gas operations.

### SUMMARY

The present invention is directed to a valve. The valve comprises a body, a hinge pin and a flapper. The body has a flow passage interrupted by a chamber at a first opening. The body defines a shoulder face disposed about the first opening in a first direction. The hinge pin is supported by the body. The flapper is attached to the hinge pin and disposed within the chamber. The flapper is movable between a first and a second position. The flapper has a closing face. The closing face comprises a flat peripheral surface conforming to the shoulder face and a surface feature. The peripheral surface abuts the shoulder face when the flapper is in the first position and the surface feature is surrounded by the flat peripheral surface.

In another embodiment, the invention is directed to a valve flapper. The flapper has a first side and a second side. The flapper comprises a closing face, a weighted protrusion, and an eye. The closing face is disposed on the first side. The closing face comprises a planar peripheral rim and a non-planar surface feature contiguous with and extending from the planar peripheral rim. The weighted protrusion is disposed on the second side. The eye has an eye axis parallel to a plane including the planar peripheral rim.

### BRIEF DESCRIPTION OF THE DRAWINGS

FIG. 1 is a sectional side view of a check valve in a closed position.

FIG. 2 is the check valve of FIG. 1 with the check valve in an open position.

FIG. 3A is a top view of a flapper for use in the check valve.

FIG. 3B is a back view of the flapper of FIG. 3A.

FIG. 3C is a front view of the flapper of FIG. 3A.

FIG. 3D is a bottom view of the flapper of FIG. 3A.

FIG. 3E is a back right top view of the flapper of FIG. 3A.

FIG. 3F is a right side view of the flapper of FIG. 3A.

FIG. 3G is a back right bottom view of the flapper of FIG. 3A.

FIG. 3H is a front left top view of the flapper of FIG. 3A.

FIG. 3J is a left side view of the flapper of FIG. 3A.

FIG. 3K is a bottom front left view of the flapper of FIG. 3A.

FIG. 4A is an exploded perspective view of a hinge assembly connecting the flapper to a halo insert.

FIG. 4B is a back bottom exploded perspective view of the hinge assembly of FIG. 4A.

FIG. 5 is a sectional view of an alternative check valve embodiment.

FIG. 6 is a side view of the check valve of FIG. 1.

### DETAILED DESCRIPTION

With reference to the Figures, a check valve is shown therein. Check valves may be utilized in oil and gas operations to control flow direction upstream from the valve by “checking” or stopping flow through the valve element when downstream flow direction reverses. The downstream flow direction could reverse due to a high pressure condition or an increase in fluid in the system downstream due to hydraulic fracturing or other oil and gas operations. Equipment, such as pumps, that are upstream of the check valve could suffer damage if flow were to try to reverse.

With reference to FIG. 6, a check valve 10 is shown having a body 11 disposed between a fluid inlet 12 and fluid outlet 14. A cleanout port 19 is formed in the body 11 between the inlet 12 and outlet 14. The cleanout port 19 is secured by a cleanout nut 18.

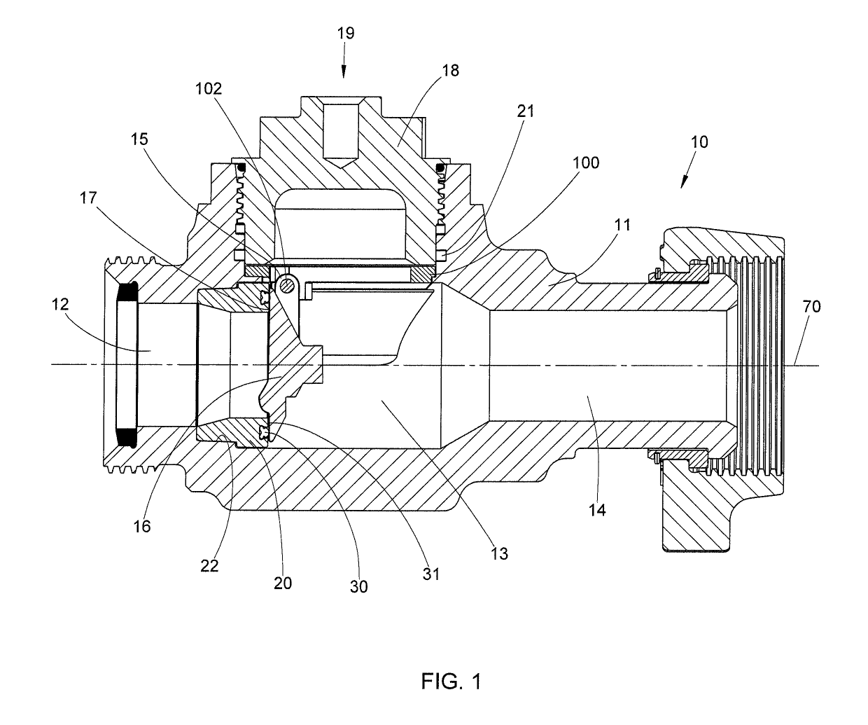

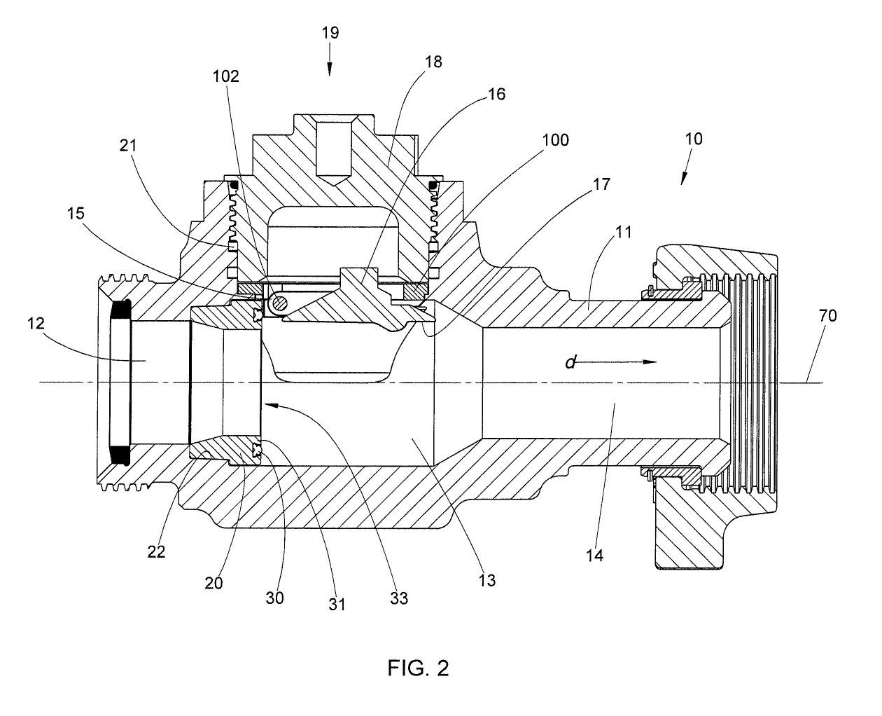

FIGS. 1 and 2 show the check valve 10 in cross-section. The inlet 12 and outlet 14 define terminal ends of a fluid flow path within the check valve 10. A central chamber 13 disposed below the cleanout port 19 interrupts the fluid flow path between the inlet 12 and outlet 14. The check valve 10 is configured such that fluid may flow only in a single direction d due to placement of a flapper 16 between the inlet 12 and outlet 14.

The flapper 16 may be located at an opening 33 where the inlet 12 is interrupted by the central chamber 13. When fluid is flowing in direction d, the flapper is in a raised position as shown in FIG. 2. In the open position, the flapper 16 does not impede fluid flowing through the check valve 10 at the opening 33.

However, when fluid flow stops, or reverses to flow from the outlet 14 to the inlet 12, the flapper 16 pivots about a hinge 15 to obstruct fluid flow as shown in FIG. 1. Thus, the flapper 16 moves to a closed position to restrict flow through the opening 33.

The flapper 16 has a first side and a second side. The first side has an inner face, or sealing face 17. The flapper 16, or its sealing face 17, may be economically subjected to hardening techniques, such as heat treatment and tungsten carbide coating. The valve body 11, conversely, may be difficult to so treat. One such technique for hardening is the addition of a coating through a high-velocity oxygen fuel spray process. Alternatively, the flapper 16 or its sealing face 17 may be made from solid carbide, boronized material, or other hardened material.

As shown, the port 19 is closed by threading the cleanout nut 18 to the valve 100 body. The cleanout port 19 allows access to the valve body 11 and the central chamber 13 for routine maintenance, inspection of valve components, and replacement and repair of components. The cleanout port 19 may define a recess for placement of the flapper 16 when in the raised position. The nut 18 may be surrounded by one or more port seals 21.

A halo insert 100, also shown in FIGS. 1, 2, 4A and 4B, is disposed in the valve to within the cleanout port 19. The halo insert 100 is annular as shown, though any shape capable of being suspended above the chamber 13 is possible. The halo insert 100 may be located on a shoulder above the chamber. The halo insert 100 is joined to the flapper 16 by a hinge 15. The hinge includes a hinge pin 102. Pressure provided by threading the cleanout nut 18 in place holds the halo insert 100 in position above the chamber 13.

A tapered seat 20 is positioned within the check valve 10 proximate the fluid inlet 12. An external profile of the tapered seat 20 preferably conforms to an internally disposed tapered wall 22 of the check valve. The taper of the seat 20 and wall 22 coordinate to open the inlet 12 from a smaller diameter distant from the central chamber 13 to a larger diameter near the central chamber 13. Because the inlet channel 12 tapers away from the central chamber 13, the seat 20 may be press-fit within that channel. Access to the seat 20, as required for installation, replacement and maintenance, is provided by the port 19.

An insert seal may be disposed between the tapered wall 22 and tapered seat 20 to prevent fluid flow between the wall and seat. The insert seal (not shown) may be an O-ring or other seal.

A flapper seal 30 is installed on the tapered seat 20. The flapper seal 30 is preferably installed on a shoulder face 31 of the tapered seat 20. The shoulder faces the downstream side of the valve 10. The shoulder face 31 is disposed about the opening 33. The flapper seal 30 is preferably made of an elastomeric material of high resiliency and tensile strength. When the flapper 16 is closed, the seal 30 blocks upstream fluid flow. Repeated contact between the flapper seal 30 and sealing face 17 will wear the sealing face rather than components of the valve body 11.

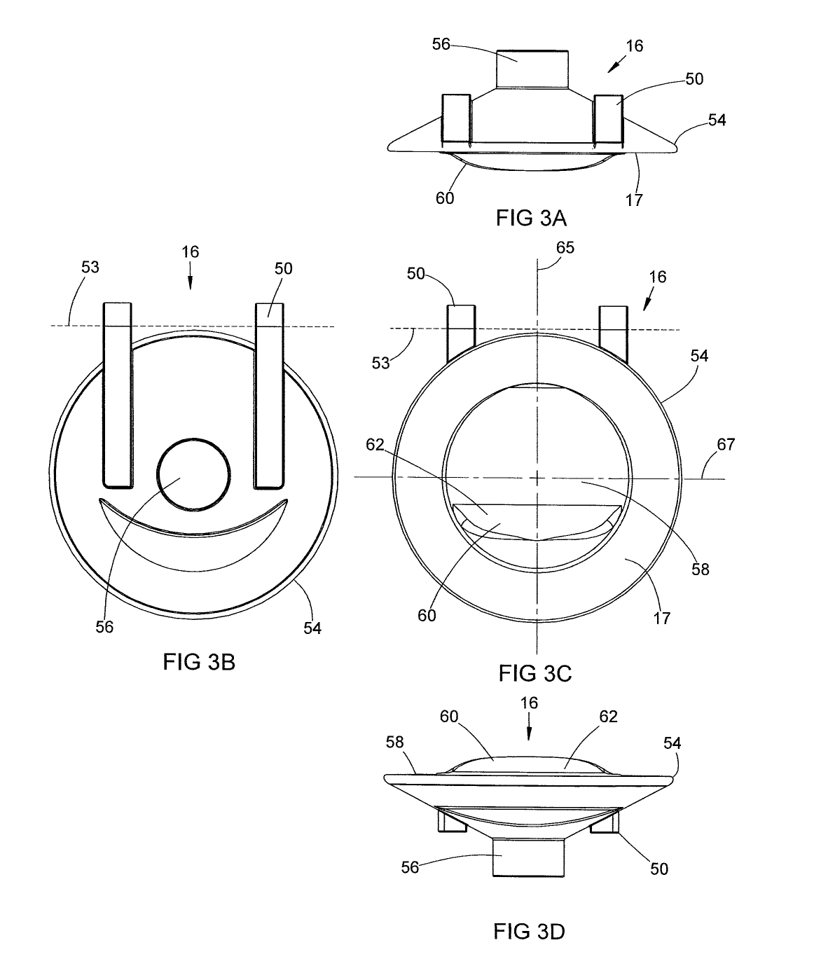

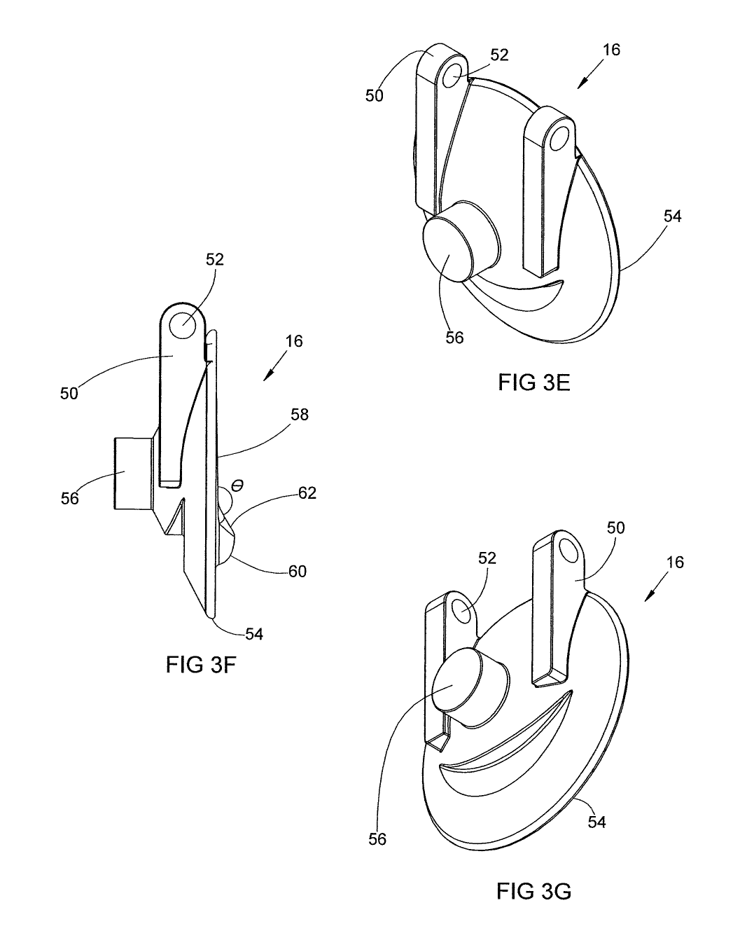

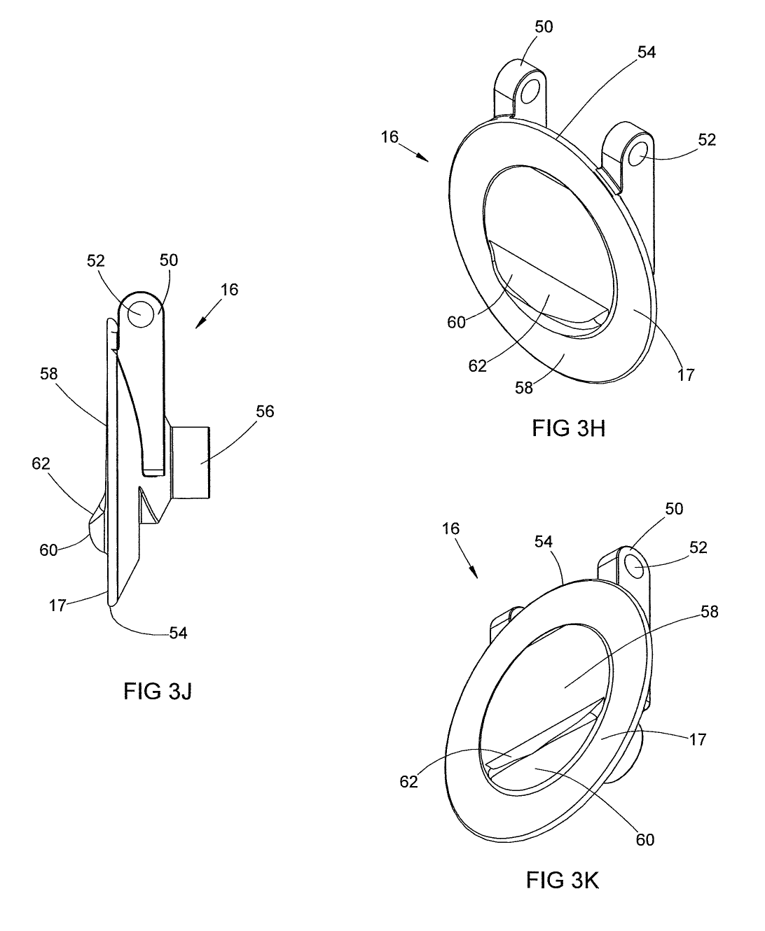

With reference now to FIGS. 3A-3K, the flapper 16 is shown in detail from multiple angles. The flapper 16 comprises one or more arms 50 having an eye 52 for connection to the hinge 15 as shown in FIGS. 1-2. The eye 52 generally defines an eye axis 53 passing through its center. The arm 50 is connected to a flapper body 54. The flapper body 54 comprises a weighted back side 56 and a raised front side 58. The sealing face 17 is a peripheral rim disposed on a flat portion on the front side 58. The front side 58 may be referred to herein as a “closing face”.

A raised surface feature 60 is disposed on the front side 58. The raised surface feature 60 directs particulates in fluid traveling through the valve 10 away from the sealing face 17. This increases the life of the flapper 16 and delays leakage due to erosion.

As best shown in FIG. 3F, the raised surface feature 60 and a contact face 62 form an included angle θ. The contact face 62 is directed toward the inlet 12 in the first and second positions. This configuration helps minimize the pressure required to open the flapper 16 and keep it open. The angle θ may be greater than 90 degrees but less than 180 degrees. For example, when 0 is 135 degrees, the contact face 62 will face the direction of flow for all flapper 16 positions between the closed and open position.

As best shown in FIG. 1, the sealing face 17 is substantially perpendicular to a centerline 70 of the fluid flow path when in the closed position. The sealing face 17 is substantially parallel to the centerline 70 when in the open position. The contact face 62 is never parallel to the centerline 70 at any point between the open and closed position. When the flapper 16 is in the open position, as best shown in FIG. 2, the sealing face 17 proximate the hinge 15 is in a “shadow” of the shoulder—meaning that fluid velocity will be lower within this region. The sealing face 17 will be likewise shielded from high velocity fluid flow by the “shadow” of the contact face 62.

The contact face 62 both minimizes pressure required to open the flapper and directs abrasive fluid away from the peripheral rim of the sealing face 17. As shown, the contact face 62 is planar, though a concave surface may also be utilized.

As best shown in FIG. 3C, the raised surface feature 60 may have bilateral symmetry about a centerline 65 which is perpendicular to the hinge pin 102. Such a construction assures that any wear on the sealing face 17 is evenly distributed about the centerline 65. Further, the raised surface feature 600 may be located entirely on one side of a centerline that passes through the geometrical center of the sealing face 17 and is perpendicular to the centerline 65. By increasing the distance of surface feature 60 and contact face 62 from the hinge 15, the moment arm of the flapper 16 increases. A longer moment arm means that lesser fluid pressures are needed to lift and maintain the flapper 16 in the open position.

The back side 56 of the flapper 16 carries a protruding ballast or weight. The protrusion biases the flapper 16 into the closed position due to gravity. Because of this bias, the flapper closes when flow stops or is reversed. As shown, the weighted protrusion is cylindrical.

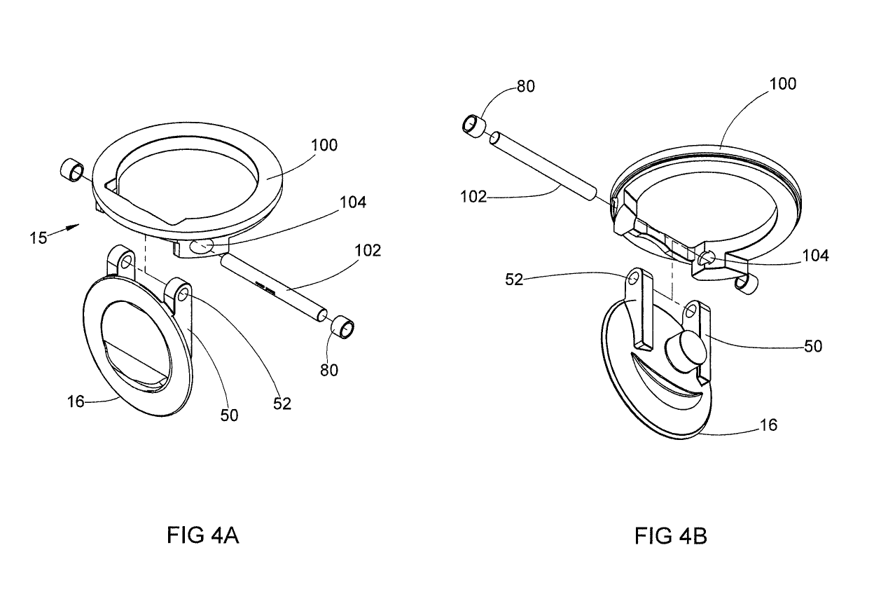

With reference to FIGS. 4A and 4B, the flapper 16 and halo insert 100 are shown. The hinge 15 is formed from at least one eye 104 formed in the halo insert 100, the hinge pin 102, and the eye 52 of the flapper 16. One or more bearings 80, such as a plain bushing, may be utilized within the eye 104.

The bearing 80 may be made with or coated with tungsten carbide or other hardening materials. Use of one or more bearings 80 between the eye 104 and the hinge pin 102 can reduce the wear on both. The hinge pin 102 may be press fit into the bearing 80 to limit relative rotation within the valve 10. Alternatively, the hinge pin 102 may fit loosely within the bearing 80, or the bearing may be provided with internally facing splines (not shown) that interface with the hinge pin 102. In such arrangements, pin 102 and bearings 80 may be hardened to reduce the wear on the pieces due to relative movement.

Reducing wear by hardening hinge elements and using the bearings 80 will prevent the flapper 16 from “dropping” within the check valve 10, causing misalignment between the flapper 16 and the opening 33.

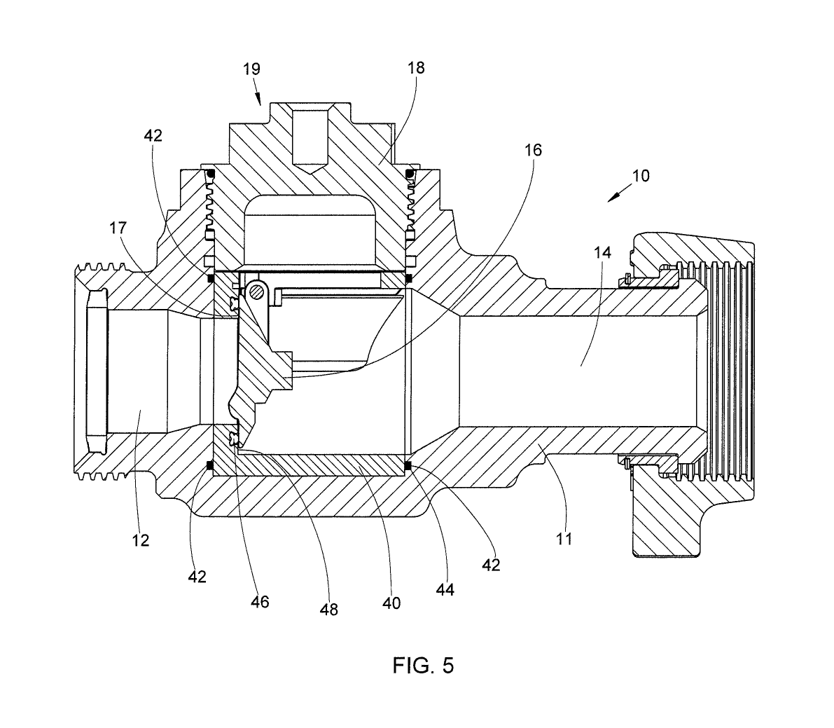

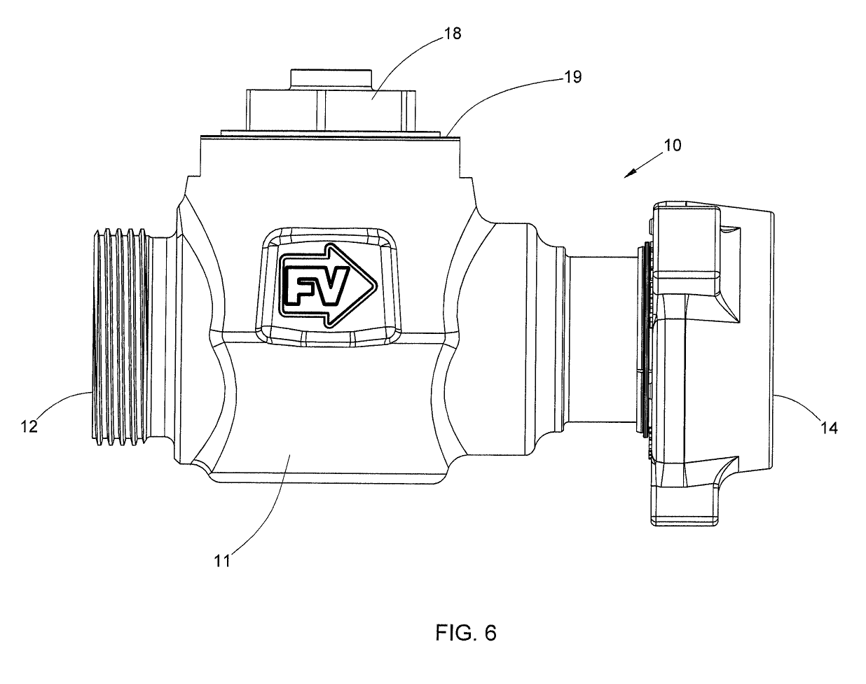

With reference now to FIG. 5, an alternative check valve 10 construction is shown. In FIG. 5, the valve to includes an annularly disposed insert 40 disposed within the valve body 11 between the inlet 12 and outlet 14. One or more insert seals 42 may be placed within a recess 44 in the valve 10, such that sealing engagement between the insert 40 and valve 10 wears the insert rather than an internal surface of the valve. The insert seal 42 may be a circular seal disposed around each of the fluid inlet 12 and outlet 14, though other shapes may be utilized. The precise shape used may depend on the internal properties of the valve 10 and insert 40.

The insert 40 has an insert flapper seal 46 formed on an internally disposed insert shoulder face 48. The flapper seal 46 seals against the sealing face 17 of the flapper 16 as in the embodiment of FIGS. 1 and 2. The annular insert 40 may be maintained and replaced through removal of the cleanout port 19.

Changes may be made in the construction, operation and arrangement of the various parts, elements, steps and procedures described herein without departing from the spirit and scope of the invention as described in the following claims.

1. A valve comprising:
a body having a flow passage interrupted by a chamber at a first opening, in which the body defines a shoulder face disposed about the first opening in a first direction;
a hinge pin supported by the body; and
a flapper attached to the hinge pin and disposed within the chamber such that the flapper is movable between a first position and a second position, the flapper having a closing face comprising:
a flat peripheral surface conforming to the shoulder face; and
a surface feature surrounded by the flat peripheral surface;
in which the peripheral surface abuts the shoulder face when the flapper is in the first position.

2. The valve of claim 1 wherein the flapper overlays the entire first opening when in the first position.

3. The valve of claim 1 wherein no portion of the flapper abuts the shoulder face when in the second position.

4. The valve of claim 1 wherein the flapper defines a centerline on its closing face parallel to the hinge pin, wherein the surface feature is disposed entirely on a first side of the centerline.

5. The valve of claim 4 wherein the hinge pin is disposed on a second side of the centerline opposite the first side.

6. The valve of claim 1 wherein the surface feature includes a planar surface that faces the first opening when the flapper is in the second position.

7. The valve of claim 1 wherein the closing face is bilaterally symmetrical.

8. The valve of claim 1 further comprising a seal positioned within the shoulder face.

9. The valve of claim 8 wherein the seal is elastomeric.

10. The valve of claim 1 wherein the hinge pin is coated with tungsten carbide.

11. The valve of claim 1 in which the surface feature extends beyond the first opening into the flow passage.

12. The valve of claim 1 further comprising an annular halo insert disposed above the chamber, wherein the halo insert defines an eye for receiving the hinge pin.

13. The valve of claim 12 wherein a bushing is disposed within the eye of the halo insert.

14. The valve of claim 13 wherein the bushing does not rotate relative to the hinge pin.

15. The valve of claim 13 wherein the bushing, the hinge pin, and the halo insert are made of tungsten carbide.

16. The valve of claim 13 in which a second eye is disposed in the halo insert for receiving the hinge pin, and wherein a second bushing is disposed about the pin and within the second eye.

17. A valve flapper having a first side and a second side comprising:
a closing face disposed on the first side comprising:
a planar peripheral rim; and
a non-planar surface feature contiguous with and extending from the planar peripheral rim;
a weighted protrusion disposed on the second side; and
an eye having an eye axis parallel to a plane including the planar peripheral rim.

18. The valve flapper of claim 17 wherein the surface feature has bilateral symmetry.

19. The valve flapper of claim 17 wherein the surface feature comprises a planar contact face disposed entirely on a first side of a centerline of the flapper, wherein the centerline is parallel to the eye axis and the first side is on an opposite side of the centerline from the eye.

20. The valve flapper of claim 17 wherein the closing face is coated with tungsten carbide.

21. The valve flapper of claim 17 wherein the non-planar surface feature and the planar peripheral rim define an included angle of greater than 30 degrees.

22. A valve comprising:
a body defining a flow passage and a chamber, wherein the chamber interrupts the flow passage at a first opening and defining a shoulder face within the chamber about the first opening; and
the valve flapper of claim 17 suspended by its eye within the chamber;
wherein the weighted protrusion biases the valve flapper such that the peripheral rim abuts the shoulder face when the valve flapper is in a first position.

23. The valve of claim 22 in which the non-planar surface feature is configured to divert the fluid material away from the peripheral rim when the valve flapper is in the second position.

24. The valve of claim 22 further comprising a seal positioned within the shoulder face.

25. A valve comprising:
a body having an internal chamber that joins upstream and downstream flow passages;
a downstream-facing shoulder surrounding the upstream flow passage at or adjacent its junction with the chamber;
a hinge supported by the body; and
a flapper attached to the hinge, positionable within the chamber and having an inner face comprising:
a peripheral flat surface seatable against the shoulder; and
a surface feature contiguous with, and fully surrounded by, the flat surface.
